(19) United States
(12) Patent Application Publication
(10) Pub. No.: US 2017/0097109 A9
(43) Pub. Date: Apr. 6, 2017

(54) Magnetic Cable Fastener

(71) Applicant: Termax Corporation, Lake Zurich, IL (US)

(72) Inventors: Daniel James Dickinson, Lincolnshire, IL (US); Michael Walter Smith, Palatine, IL (US)

(73) Assignee: TERMAX CORPORATION, Lake Zurich, IL (US)

(21) Appl. No.: 14/462,538

(22) Filed: Aug. 18, 2014

Related U.S. Application Data
(63) Continuation-in-part of application No. 13/831,525, filed on Mar. 14, 2013.
Application No. 13/831,525 is a continuation-in-part of application No. 12/983,010, filed on Dec. 31, 2010, now Pat. No. 8,287,034.
Application No. 12/983,010 is a continuation-in-part of application No. 12/464,867, filed on May 13, 2009, now Pat. No. 8,615,852.

(51) Int. Cl. F16L 3/12; B60R 16/02; F16L 3/13; F16M 13/02; F16B 1/00

(52) U.S. Cl. CPC F16L 3/12; F16M 13/022; F16B 1/00; F16L 3/13; F16L 3/1222; B60R 16/0215; F16B 2001/0035

(57) ABSTRACT

A magnetic cable fastener includes a magnetic fastener, a boss, a base, and a loop coupler attached to the base. The loop coupler is attached to the base and is operable to attach to another structure. The loop coupler may be a cable, wires, electrical conduit, rope, adjustable strap, and a tie wrap or suitable object. According to one embodiment, the loop coupler may further include at least two fingers. The fingers are operative to flex or compress appropriately to permit the cables to enter the fingers. According to another embodiment, the loop coupler is a solid loop to permit for example, a cable strap to be inserted and attach the cable strap to the loop coupler. Thus, the magnetic cable fastener may secure one or more cables via the loop fingers or solid loop or other suitable cable coupler.

### RELATED APPLICATIONS

This is a continuation in part application claiming priority from an application entitled “Magnetic Bracket and Method” having a docket number P055D and a Ser. No. 13/831,525, and having a filing date of Mar. 14, 2013, the entire disclosure of which is incorporated herein by reference.

Which is a continuation in part application claiming priority from an application entitled “Magnetic Fastener Clip” having a docket number P055 and a Ser. No. 12/464,867, and having a filing date of May 13, 2009, now U.S. Pat. No. 8,615,852 the entire disclosure of which is incorporated herein by reference.

Co-Pending patent application entitled “Magnetic Bracket and Method” having a docket number POSSE and serial number TBD having a filing date the same as this patent application the entire disclosure of which is incorporated herein by reference.

### FIELD OF THE INVENTION

The invention relates generally to devices for fastening objects, and more particularly to a magnetic fastener to secure cables or to attach onto an engagement structure, such as a vehicle chassis, a hollow substrate, a wall, a plate or any suitable surface.

### BACKGROUND OF THE INVENTION

A number of devices and fasteners are currently available to secure cables or for fastening panels, body panels, building structure, and automobile interior trimpiece panels to the chassis of a vehicle. For example, adjustable straps, fastener clips and other devices are used to secure cables. Clamps and cable ties are used to secure cables in electrical wiring and boxes. As used herein, a body panel refers to, an electrical box or conduit or for example, any interior or exterior structure attached to a vehicle, such as a plastic or metal interior trim piece or any interior trimpiece. The body panel may be any suitable exterior body panel, such as a fender, bumper, quarter panel or door panel. The chassis of the vehicle may include any substrate, plate, body panel, structural framework, chassis component or subcomponent, support component, wall or any suitable object or combination.

Attaching wires or cables to a building structure, electrical box or body panel typically requires securing wires, cable clamps, electrical boxes, screw in cable clamps, straps, tape or clips already fastened to a wire assembly. At least some of the fasteners require extended height or blind insertion and installation of the fasteners because the installer is not able to view the fastener or the mounting point on the body panel. These known fasteners require fastening with a screw driver or wrench and thus are cumbersome and difficult to install especially in inaccessible areas. Nor can they be installed without a screw driver or wrench for example on an electrical box, conduit or in automobile environments that can be somewhat harsh. If the cable bracket, screw or clip is loosened or broken after installation, the cable may fall or sag again presenting an aesthetically undesirable appearance. Further, replacement of an installed, broken cable bracket, screw or clip can again be difficult.

Magnets may be used to reduce the problem of the blind fastener application. For example, fastener clips are known that attach to an automobile headliner or the like using adhesive, and which firmly connects to a magnet. Thus, magnetic fastening clips do not require aligning a fastener with a mating hole and attachment of the fastener to the hole.

Regarding automotive applications, interior automobile fasteners, such as screws, are known to retain a body panel to a vehicle chassis. An automobile body panel is typically made of cloth, foam, plastic or other suitable material and generally includes a suitable substrate layer. A fastener clip may be secured to the substrate by an adhesive, such as glue, and is then attached to the underlying roof structure.

These known clips however are neither sufficiently rugged nor flexible for example on an electrical box, conduit or an automobile assembly line that can be somewhat harsh. These fastening clips typically do not have a long useful life to support the cables and prevent staking. During installation the cables can be moved, stretched or twisted inconsistently. However, the fastener device is typically required to secure the cables to the chassis that may have sheet metal with different amounts of curvature or thicknesses throughout. If the sheet metal varies in curvature or thickness or if for example, tolerances in production of the chassis or in the electrical box or conduit, then engagement of one fastener may not provide suitable magnetic engagement or will otherwise result in movement. As a result, sagging, wear, squeaks, rattles, buzzing, corrosion and loss of elasticity and loss of sealing may result, especially after years of operation and exposure to vibration and other environmental conditions. As such, these fastener clips do not provide sufficient performance or convenience.

Conventional fastener devices typically do not adequately fasten to a range of sheet metal thicknesses and do not minimize or eliminate buzzing and rattling and do not sufficiently accommodate variations in production tolerances. As a result, these clips do not properly fasten the body panel to the chassis, break or otherwise fail under these conditions. Further, replacement of an installed, broken clip can be difficult.

### BRIEF DESCRIPTION OF THE DRAWINGS

FIG. 1 is an exploded view of a magnetic cable fastener according to one embodiment;

FIG. 2 is an exploded view of a magnetic cable fastener according to another embodiment;

FIG. 3 is a side view of a portion of the magnetic cable fastener according to one embodiment;

FIGS. 4-6 are perspective views of the magnetic cable fastener assembly according to one embodiment;

FIGS. 7-12 are various perspective views of the magnetic cable fastener according to one embodiment;

FIGS. 13-17 are various perspective views of the magnetic cable fastener assembly according to one embodiment; and

FIGS. 18-21 are various perspective views of the magnetic cable fastener with a closed coupler according to one embodiment.

### DETAILED DESCRIPTION OF THE PREFERRED EMBODIMENTS

A magnetic cable fastener includes a magnetic fastener, a boss, a base, and a loop coupler attached to the base. The loop coupler is attached to the base and is operable to attach to another structure. The loop coupler may be a cable, wires, electrical conduit, rope, adjustable strap, and a tie wrap or suitable object. According to one embodiment, the loop coupler may further include at least two fingers. The fingers are operative to flex or compress appropriately to permit the cables to enter the fingers. According to another embodiment, the loop coupler is a solid loop to permit for example, a cable strap to be inserted and attach the cable strap to the loop coupler. The magnetic fastener has a hole with suitable shape and/or diameter to adjustably fasten with the boss or alternatively with at least one ratchet to adjustably fasten the magnetic fastener. Thus, the magnetic cable fastener may secure one or more cables via the loop fingers or solid loop or other suitable cable coupler.

According to one embodiment, the boss has at least two arms and a spring finger attached to the base. The spring finger is operable to move between at least part of the arms. The spring finger has a first position to allow the arms to bend towards each other and permit the magnetic fastener hole to pass past an elbow on the magnetic fastener. The spring finger has a second position to impede the arms from bending towards each other such that the elbows are operable to engage the magnetic fastener hole. A magnetic fastener has a hole with suitable shape and diameter to adjustably fasten with at least one of the arms.

According to one embodiment, one end of the boss is attached to the base and the other end has the two or more ratchets to adjustably fasten the magnetic fastener (shown in the parent application). Alternatively, either or both ends may have the two or more ratchets. A magnetic fastener has a hole with suitable shape and/or diameter to adjustably fasten with at least one of the ratchets and adjustably fasten the magnetic fastener. According to another embodiment, an umbrella is positioned between the base and the magnetic fastener. The umbrella is operative to flex or compress appropriately to permit the magnetic fastener to engage at least one of the two or more ratchets. The magnetic cable fastener adapts to different surface curvatures and thicknesses. The magnetic cable fastener is operative for blind attachment of cables to a structure, such as an electrical box, conduit, a vehicle chassis i.e. door frame, chassis or roof. The boss may optionally be welded to hold the magnetic fastener against the umbrella. An optional carrier is attached to the base to provide additional height for suitable applications.

Among other advantages, the magnetic cable fastener relatively easily facilitates attachment of cables to an electrical box, conduit, body panel with the structure, such as the chassis, instrument panel structure, pillar or roof, vehicle door frame, such that a single adjustable magnetic cable fastener may be used with different depth attachment requirements, sheet metal curvatures and/or thicknesses. For example, a vehicle door, pillar, instrument panel structure, chassis, or roof may have different sheet metal curvatures and thicknesses at various parts of the vehicle. Since the fastener clip adapts automatically to different attachment requirements, depths, sheet metal curvatures and thicknesses, the same fastener clip may be used throughout the vehicle thus eliminating the need for specific fastener clips for specific roof curvatures and thicknesses. In automotive applications, the body panel may be an automatable headliner, door panel, instrument panel, A, B, C, D, etc. pillar panel, bumper, fender, quarter panel, grill, hood, roof, trunk panel or any suitable interior or exterior panel.

According to one embodiment, the magnetic fastener has a hole with a diameter to receive at least one of the two or more ratchets on the boss, and adjustably fasten the magnetic fastener. The umbrella is operative to flex to permit the magnetic fastener to engage at least one of the two or more ratchets. According to one embodiment, the boss is attached to the magnetic fastener at one of two or more ratchets corresponding to one or more ratchet positions. The umbrella is operative to flex or compress according to the ratchet setting corresponding to the required depth or length and to an appropriate curvature. As the umbrella flexes, the magnetic fastener may pivot about the boss for example at an angle to allow the magnetic fastener to adapt to different surface curvatures while securely fastened to the body panel. According to one embodiment, the magnet does not engage the boss. Thus, the umbrella support structure adapts to different attachment lengths, variations of sheet metal roundness and thicknesses thus allowing the magnet fastener to adjust to different depths while pivoting and maintaining a high level of extraction force. During installation the engagement magnet continuously adapts to variations in curvature and dimensions of the vehicle roof and/or in the body or headliner panel. Thus, only a single magnetic cable fastener need be used with a vehicle or application even if different attachment lengths are required at different attachment points or even if the curvature or thickness of the sheet metal varies substantially. According to another embodiment, the boss is welded to the magnetic fastener to securely fasten the headliner to the roof and provide long reliable life.

The magnet, along with an optional carrier, permits relatively easy insertion of the magnetic cable fastener into a vehicle chassis, pillar, instrument panel structure, door, roof or suitable body panel while providing a relatively high level of extraction force from the body panel. Assembly of the body panel onto the vehicle chassis is very easy and requires no or a relatively low level of insertion force compared to the extraction force, and as a result provides many ergonomic advantages. For example, the relatively low level of insertion force is particularly advantageous for assembly line operators who repetitively insert body panels onto the vehicle chassis. The relatively low level of insertion force required for blindly inserting the body panel into the vehicle chassis may result in fewer injuries to the assembly workers, including injuries related to repetitive stress syndrome. Further by selecting a single fastener or reducing the number of different fasteners for different sheet metal curvatures and thicknesses, confusion during assembly is eliminated since the same type or a reduced number of fasteners may be used for all or most body panel fasteners. Thus, an electrician, installer, or assembly worker need not worry about selecting the wrong fastener.

The relatively high level of extraction force, characteristic of the magnetic cable fastener, securely attaches to the building or vehicle chassis. Further, the magnetic cable fastener continuously adapts to changes in environmental conditions such as vehicle flexing, pushing by passengers, vibration and thermal expansion. For example, the magnetic cable fastener may adapt to changes in thermal expansion, especially due to the differences in thermal expansion rates between dissimilar metals with respect to the vehicle chassis components and/or between plastic components such as the interior trim panels attached to the metal vehicle chassis. The fastener clip may also fasten to plastic and/or metal engagement structures. The fastener clip may be made of anti-corrosive material such as plastic or treated metal to provide long reliable service life.

Yet another advantage is that the magnetic cable fastener is relatively easy to manufacture using relatively inexpensive manufacturing processes and materials. The use of the magnetic cable fastener decreases installation, assembly and production costs, increases worker productivity and efficiency, improves reliability and quality and decreases overall vehicle assembly, warranty and maintenance costs. The magnetic cable fastener improves reliability both in the short term and in the long term, while further improving safety and quality.

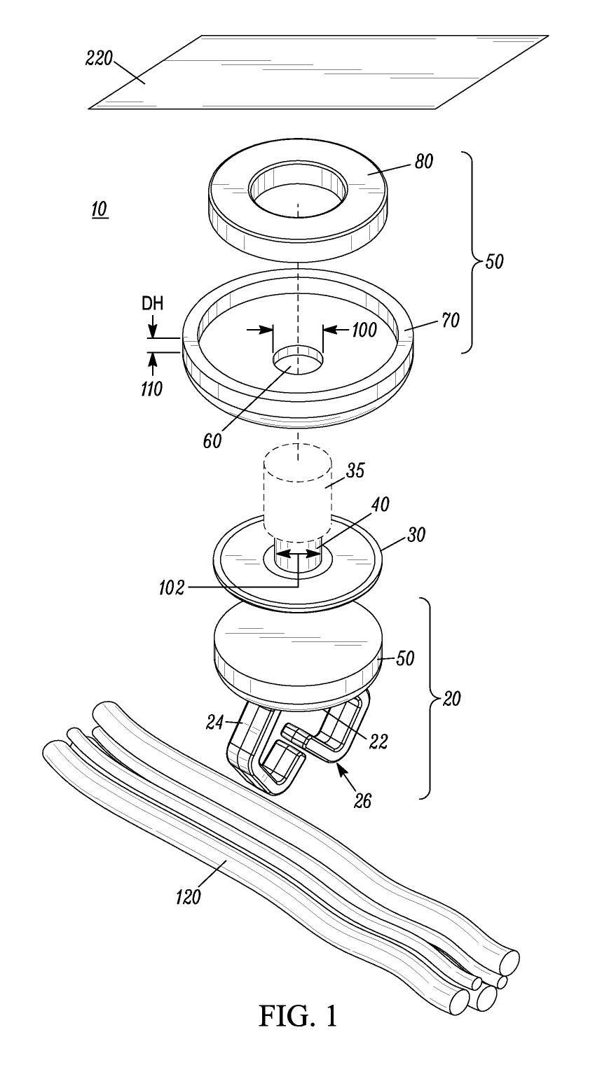

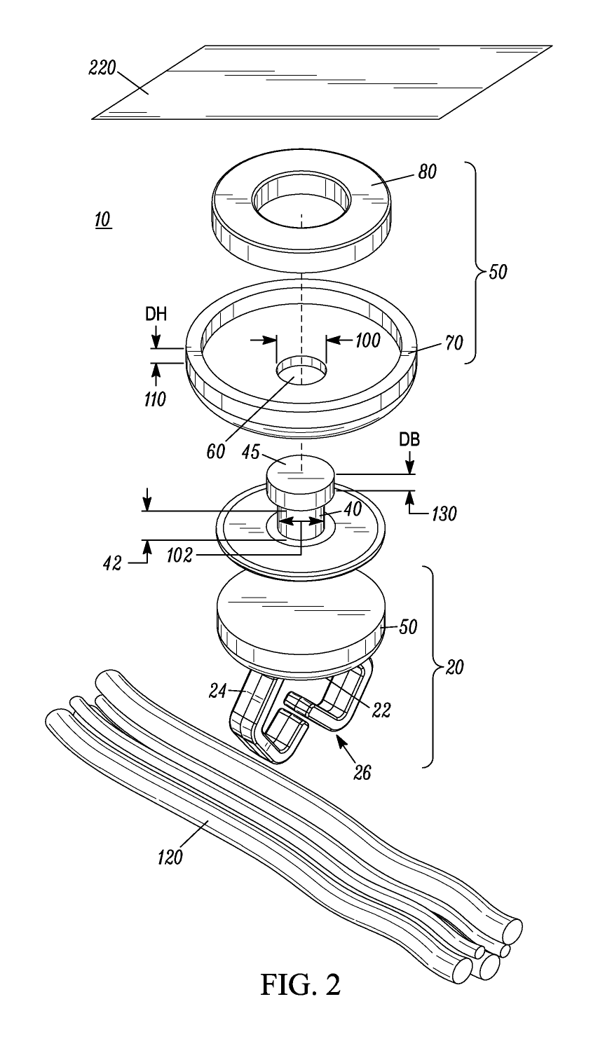

FIG. 1 is a perspective view of a magnetic cable fastener 10 according to one embodiment. The magnetic fastener 10 includes a base 20, an optional umbrella 30 and a boss 40 attached to the base 20. A magnetic fastener 50 has a hole 60 with suitable shape and diameter to adjustably fasten with boss 40 via a suitable fastener 35 described below. The optional umbrella 30 is positioned between the base 20 and the magnetic fastener 50. As shown but not limited to FIG. 1 base 20 may be or may include a coupler 26 suitable to engage a mounting structure (not shown) according to one embodiment. For example, coupler 26 may further include inner rib 22 and outer rib 24. Coupler 26 is connected to magnetic fastener 50 by a post 45 shown in FIG. 2. According to one embodiment, post 45 is coupled to or is the same as or an extension to boss 40.

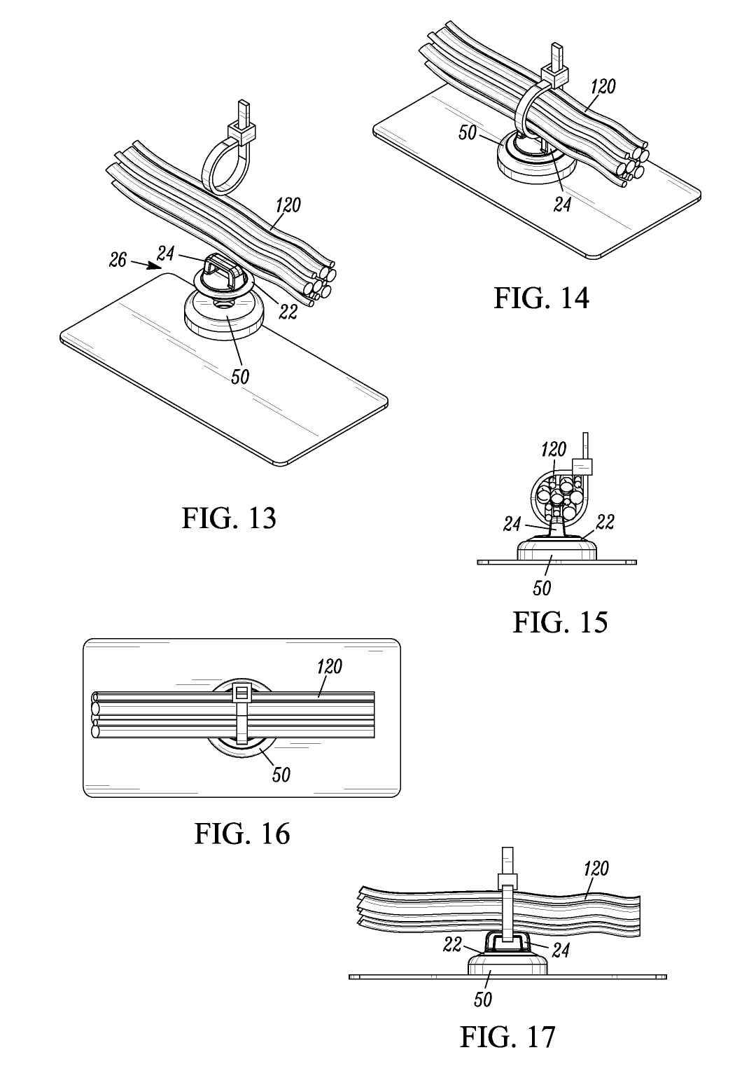

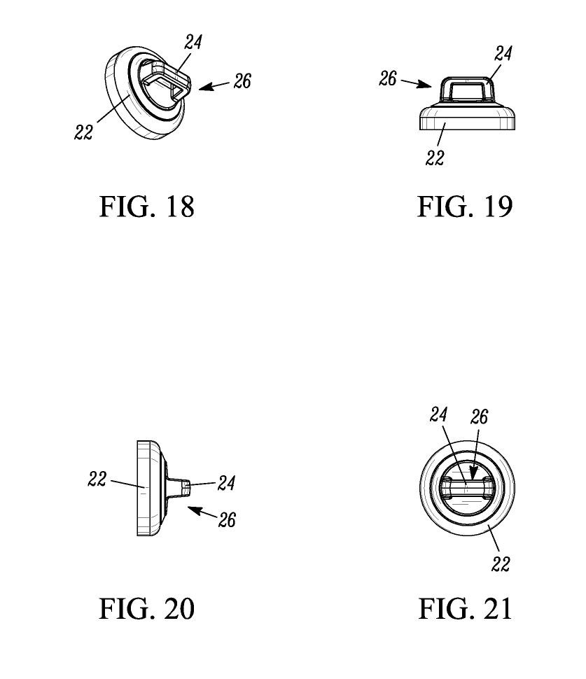

As shown in FIGS. 13-21, according to one embodiment, inner rib 22 and outer rib 24 are connected or continuous. Inner rib 22 outer rib 24 and post 300 may be sized to suitably engage a panel mounted tower with a side-slot in a body panel such as a headliner.

According to one embodiment, one end of the boss 40 is attached to the base 20 and the other end has as fastener 35, the two or more ratchets 245 (described in a parent application). Alternatively, either or both ends of the boss 40 may have the two or more ratchets 245. A magnetic fastener 50 has a hole 60 with suitable height, shape and diameter to adjustably fasten with at least one of the ratchets 245 and adjustably fasten the magnetic fastener 50. According to exemplary embodiments contemplated in at least FIGS. 1 and 2, the two or more ratchets (not shown) extend on the boss 40 below umbrella 30 such that the loop coupler 20 engages the two or more ratchets.

As shown in FIG. 2, the base 20 having the coupler 26 includes at least two fingers 22, 24 and may be any suitable shape such as diamond, triangular, square, oval, round, rectangular. The coupler 26 and the at least two fingers 24 may have any suitable size and relative spacing between the at least two fingers 24. Alternatively, loop coupler 26 may include any attachment mechanism suitable to couple or attach to a body panel such as a nut, bolt, weld stud, thread stud, button head, clip, panel clip, retainer, panel mounted receptacle, retainer washer, or rivet, cable tie, wire clip, hook and loop fastener (Velcro®), sticky tape, double faced tape, spike array, or any suitable combination. The loop coupler 26 may attach a suitable cable 120, such as a wire, conduit, electrical box, an adjustable strap, tie wrap, rope, string, or any suitable object.

Several different types of fasteners 35 designs are shown however any suitable design is contemplated. The boss 40 has a fastener 35 having at least one of: a weld, a prong, a nut, a rounded tip, a pointed tip, a pin, and/or a barb. The boss 40 may be fastened to the magnetic fastener 50 via any general suitable fastener 35 shown generically in FIGS. 1, 2 and 3. According to one embodiment, the suitable fastener 35 may be the ratchets 245, however the suitable fastener may be a nut, pin, wedge, prong(s), spring, washer, hook(s), rib lock, clamp, spring finger, or any mechanism suitable to fasten magnetic fastener 50. Suitable fastener 35 may be made of plastic, metal or any suitable material or as described below. Although some examples of suitable fastener 35 are described and shown and further described below, including adjustable type fasteners, any suitable type of fastener may be employed. For example, in an embodiment shown in FIG. 1, the boss 40 is welded to the magnetic fastener 50 to form a weld 45 for fastening the magnetic fastener 50 to the boss 40. By way of example, the boss 40 attaches the magnetic fastener 50 to the base 20 by: micro welding, ultrasonic welding (an ultrasonic horn melts the plastic boss in a pre-determine location to form a boss head), heat welding, spring finger, screw and pin or any suitable combination thereof.

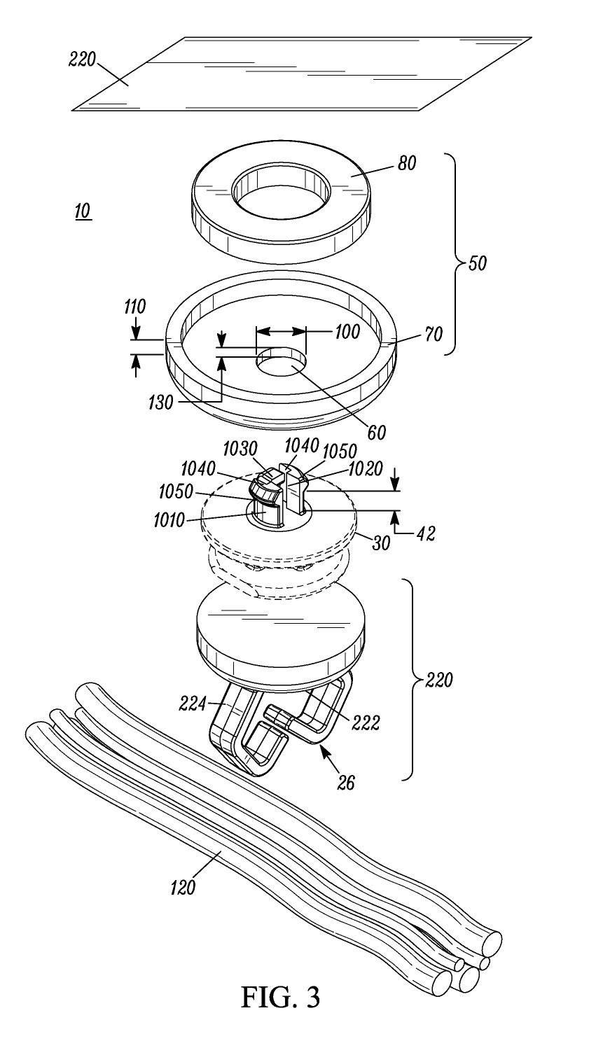

As shown in FIG. 3, according to one embodiment, the boss 40 has at least two arms 1010, 1020 and a spring finger 1030 attached to the base 20, 30. The spring finger 1030 is operable to move out of and in between at least part of the arms 1010, 1020. For example, the arms 1010, 1020 may have notches 1040 on the top of arms 1010, 1020 to bend toward each other during insertion of the magnetic fastener 50. A magnetic fastener 50 has a hole 60 with suitable shape and diameter 100 to adjustably fasten with at least one of the arms 1010, 1020. According to another embodiment, arms 1010, 1020 have multiple ridges or elbows 1050 to engaging the magnetic fastener 50 to provide a greater range of attachment distance.

The spring finger 1030 has a first position to allow the arms 1010, 1020 to bend towards each other and permit the magnetic fastener hole 60 to pass past an elbow 1050 on the arms 1010, 1020. The spring finger 1030 has a second position after the magnetic fastener 50 passes past elbows 1050 and snaps within a length 42 shown on arms 1010, 1020. Arms 1010, 1020 flex back away from each other as hole 100 passes by elbows 1050. The hole 60 has a diameter 100 is sized to cause finger hook 1030 to bend in between arms 1010, 1020. The finger hook 1030 is bent inwardly to impede the arms 1010, 1020 from bending towards each other such that the elbows 1050 are operable to engage the magnetic fastener hole 60 and hold the magnetic fastener 50 captive. As a result, finger hook 1030 when bent inwardly securely spreads arms 1010, 1020 to securely fasten magnetic fastener 50 captive. Prying finger hook 1030 to spring away from arms 1010, 1020, such as with a screw driver, permits arms 1010, 1020 to come together releasing magnetic fastener 50.

The arms 1010, 1020 and optional umbrella 30 may be a unitary plastic component and may be injection molded with the base 20, boss 40. Alternatively, a rubber or other suitable material may be used for optional umbrella 30 and placed onto the base 20 and then readied for fastening. According to another embodiment, the base 20, boss 40 may be multiple components that are made or assembled in one or more injection steps.

According to one embodiment shown in FIG. 1 and FIG. 2, the umbrella 30 is positioned on the coupler 20 itself however depending on the gap between the body panel and the structure, the boss 40 or other components as described below may affect design criteria for dimensions of each component. For example, the magnetic fastener 50 may be mounted on the coupler 20 and thus no separate umbrella 30 is included, since the base 20, 50 may function as the umbrella. Depending on the space requirement between the cable and the panel or engagement surface, the height of the magnetic cable fastener 10 may be increased with boss 40 of different heights and with more than 2, 3, 4, 5, 6, 7 or more ratchets 245. Alternatively, the height of the magnetic cable fastener 10 may be further sized by adjusting the height of a thicker base 20 or longer boss 40, not shown. The boss, 40 is attached to the umbrella 30 and extends outwardly from the umbrella 30 and away from the base 20. The boss 40 may be fastened to the magnetic fastener 50 via any general suitable fastener 35 shown generically in FIGS. 1 and 2. According to one embodiment, the suitable fastener 35 may be the ratchets 245, however the suitable fastener may be a nut, pin, wedge, prong(s), spring, finger, washer, hook(s), rib lock, clamp or any mechanism suitable to fasten magnetic fastener 50.

According to one embodiment, the magnetic fastener 50 further comprises a holder 70 and a magnet 80. The magnetic fastener 50 may be a single piece (i.e. a magnet without a holder) or multi-piece device. Although the fastener clip 10 is shown in FIGS. 1-21 with a round magnetic fastener 50 any suitable shape may be used including oval, square, rectangular, triangular or polygon. The magnetic fastener 50 has a hole 60 with a magnetic fastener diameter 100 to receive the boss 40. The boss 40 has a thickness (diameter) 102. The magnetic fastener hole diameter 100 may be sized greater than boss thickness 102 creating an optional gap between the boss 40 and the magnetic fastener hole 60 to allow the magnetic fastener 50 to tilt about the boss 40 such that the magnetic fastener 50 may conform to the contours of a surface such as a roof or body section. The hole 60 of the magnetic fastener 50 has a magnetic fastener height DH 110. The magnetic fastener height DH 110 may be sized also to allow the magnetic fastener 50 to tilt.

The boss 40 is attached to the magnetic fastener 10 such that, for example either the boss 40 and/or the umbrella 30 is operative to optionally flex or compress to permit the umbrella 30 to pivot about the boss 40. According to one embodiment, the hole diameter 100, the magnetic fastener height 110, the boss diameter 102, and/or a boss height 42 are sized to allow the umbrella 30 to pivot about the boss 40 while remaining securely fastened to the boss 40. Any suitable combination of parameters may be sized to permit the desired amount of pivoting, flexing and or compression according for example to the curvature of an automobile body panel such as the roof. Similarly, the magnetic fastener thickness 110, the boss height 42 and/or a boss diameter 102, are sized to allow the umbrella 30 and/or the magnetic fastener 50 to pivot about the boss 40.

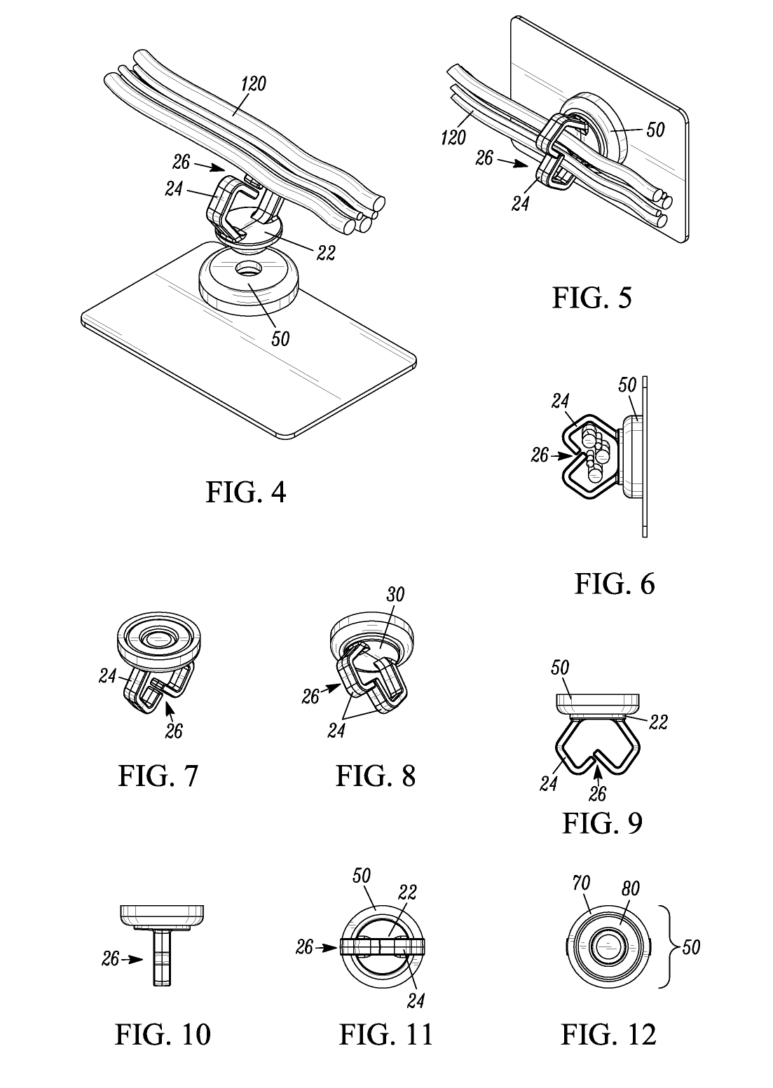

FIGS. 4 and 5 are side views of the magnetic cable fastener 10 suitable for attaching a cable 120. The loop coupler 24 may have fingers 22, 24 that are operable to open to allow insertion of a cable into the fingers. The fingers 22, 24 may then close with a gap between the fingers 22, 24, a relatively small gap, no gap such that the finger tips touch or the finger tip cross. Each finger 22, 24 may be curved, angled, bent or smooth. For example, the fingers 22, 24 may have a bend to function as a knuckle hinge at a midpoint between the fingers. The finger tips as shown may have a bend to function as a second hinge near the finger tip. Thus, as the cable 120 is inserted into the finger tip hinge and the knuckle bend sufficient to allow a gap to form between the two fingers 22, 24. As the cable 120 passes through the finger tips, the finger tip hinge and the knuckle spring back to cause the finger tips to again close or reduce the gap between the finger tips. Thus, the fingers 22, 24 close the gap between the finger tips or reduce the gap in order to impede removal of the cable 120 or otherwise hold the cable 120 captive.

FIG. 5 is a perspective view of the magnetic cable fastener 10. The magnetic cable fastener 10 may be pre-assembled by attaching the base 20, (22, and 24) of the magnetic cable fastener 10 to a panel as described above, such as a plate, to form a body panel assembly (not shown). The fingers 22, 24 may tightly couple the cable 120 with little space between the cable wires or may loosely couple the cable 120 and any intermediate wires. The coupler 26 according to one embodiment may further comprise base holes 500 shown in FIG. 5 of co-pending application Ser. No. 12/464,867. The base holes 500 permit attachment to the body panel by applying glue or any suitable fastener. Tapered holes that have a larger diameter on the top side of the coupler 26 (closest to the magnetic fastener 50) than on the bottom side (mating with the body panel) filled with glue will further provide a mechanical connection as well as the chemical connection as a result of the adhesive properties of the glue. The body panel assembly thus comprises a body panel attached to the magnetic cable fastener 10 attached via glue or other suitable fastener such as a screw, bolt, rivet or any suitable fastener to attach the body panel to the magnetic cable fastener 10.

FIGS. 6-12 provides several views of the magnetic cable fastener 10. The cable 120 may be a group of wires with or without a shield. The cable 120 may have any suitable diameter suitable to be inserted into the fingers 24. Thus the fingers 22, 24 may have a suitable number of hinges, with placement of the hinges, and a length, height and diameter suitable to accept a cable with a variety of cable diameters. Accordingly, the magnetic cable fastener 10 may replace one or more conventional fasteners that would attach a cable 120 to a magnetic object. Instead of requiring different conventional fasteners for different size and height requirements, the magnetic fastener 10 may magnetically attach to a building structure, chassis or a metal ring surrounding the slot in the body panel and adjust to different size and height requirements.

The body panel assembly is operatively inserted as a single unit into a structure, such as a vehicle chassis, pillar, roof, instrument panel or frame to form a vehicle with the magnetic clip. The magnetic cable fastener 10 adapts to different chassis curvatures such that an angle between the magnetic fastener 50 and the coupler 20 is operative to vary continuously.

According to one embodiment, the fastener clip 10 is made of: magnetic steel or any suitable metal. The body panel may be constructed from plastic or from any suitable material such as plastic, vinyl, cloth, wood, steel, aluminum, magnesium, carbon fiber or any suitable material.

The optional umbrella 30 shown is in spaced apart relation from the base 20, such that the umbrella 30 is positioned over and above the coupler 20 so as to define an open area. The height of the optional carrier 300, umbrella 30, coupler 20 or magnet holder 70, or any suitable combinations may be sized to provide the appropriate spacing between the body panel, such as a headliner and the chassis such as the roof.

The umbrella 30 may be of any suitable shape and length such that the umbrella 30 flexes as the magnetic fastener 50 pivots about the boss 40, 240, 840. According to one embodiment, the umbrella 30 substantially engages the magnetic fastener 50 at for example two or more points to provide support directly on the magnetic fastener 50. According to one embodiment, the umbrella 30 is made of rubber, plastic, metal or any material that is flexible enough to support the magnetic fastener 50 and allow the magnetic fastener 50 to flex.

For example, these figures illustrate the configuration of the magnetic clip after installing the umbrella 30, but before the magnetic fastener 50. The umbrella 30 may be a plastic component and may be injection molded with the base 20, boss 40. Alternatively, a rubber or other suitable material may be used for umbrella 30 and placed onto the coupler 20 and then readied for fastening.

According to one embodiment, the magnetic cable fastener 10 has a rubber coating. According to one embodiment, the base 20, boss 40 are injection molded as a single plastic component, thought multiple components may be assembled in one or more injection steps. The angle or inclination, sharpness and length of boss 40 may vary depending on the diameter and shape of a slot in the vehicle chassis. Thus it is evident to one skilled in the art that the suitable fastener 35 is shown and described as yet another embodiment to illustrate that the structure for fastening the magnetic fastener is not limited to the examples provided.

The umbrella 30, boss 40, carrier (extended boss 40), holder 70 and base 20, or any combination of components may be made from: Polypropylene (PP), glass fill, acetal, plastic, vinyl, rubber, plastisol, plastic, acetal, polyacetal, polyoxymethylene, nylon, fiberglass and carbon fiber and Acrylonitrile butadiene styrene (ABS), or any suitable material and combination thereof.

Polypropylene or polypropene (PP) is a thermoplastic polymer. Typical commercial polypropylene is isotactic and has an intermediate level of crystallinity between that of low density polyethylene (LDPE) and high density polyethylene (HDPE); its Young's modulus is also intermediate. PP is normally tough and flexible, especially when copolymerised with ethylene. This allows polypropylene to be used as an engineering plastic, and thus may be used in place of other materials such as ABS, acrylic or certain other plastics. Polypropylene is reasonably economical, and has good resistance to fatigue.

Polypropylene has a melting point of ˜160° C. (320° F.), as determined by Differential scanning calorimetry (DSC) and thus is suitable for injection molding. The MFR (Melt Flow Rate) or MFI (Melt Flow Index) is a measure of PP's molecular weight. This helps to determine how easily the melted raw material will flow during processing. Higher MFR PPs fill the plastic mold more easily during the injection or blow molding production process. As the melt flow increases, however, some physical properties, like impact strength, may decrease and thus melt flow may be controlled to maintain a high degree of strength.

There are three general types of PP: homopolymer, random copolymer and block copolymer. The comonomer used is typically ethylene. Ethylene-propylene rubber or EPDM added to PP homopolymer increases its low temperature impact strength. Randomly polymerized ethylene monomer added to PP homopolymer decreases the polymer crystallinity and makes the polymer more transparent.

Manufacturing

Melt processing of polypropylene can be achieved via extrusion and molding. Injection molding may be used to obtain the desired shape. The related techniques of blow molding and injection-stretch blow molding may also used, which involve both extrusion and molding.

PP offers the ability to tailor grades with specific molecular properties and additives during its manufacture. For example, antistatic additives can be added to help PP surfaces resist dust and dirt. Many physical finishing techniques can also be used on PP, such as machining. Surface treatments can be applied to PP parts in order to promote adhesion of printing ink and paints.

Plastics

According to another embodiment, the umbrella 30, carrier 300, boss 40 and coupler 20 may be made from any suitable plastic including: Cross-linked polyethylene (PEX or XLPE) • Polyethylene (PE) • Polyethylene terephthalate (PET or PETE) • Polyphenyl ether (PPE) • Polyvinyl chloride (PVC) • Polyvinylidene chloride (PVDC) • Polylactic acid (PLA) • Polypropylene (PP) • Polybutylene (PB) • Polybutylene terephthalate (PBT) • Polyamide (PA) • Polyimide (PI) • Polycarbonate (PC) • Polytetrafluoroethylene (PTFE) • Polystyrene (PS) • Polyurethane (PU) • Polyester (PEs) • Acrylonitrile butadiene styrene (ABS) • Polymethyl methacrylate (PMMA) • Polyoxymethylene (POM) • Polysulfone (PES) • Styrene-acrylonitrile (SAN) • Ethylene vinyl acetate (EVA)) • and Styrene maleic anhydride (SMA).

Acetal

According to another embodiment, the umbrella 30, carrier 300, boss 40 and coupler 20 may be made from polyoxymethylene plastic or any suitable acetal based plastics. Acetal based plastics are chemically resistant, have very low water absorption, are resistant to hydrolysis by base.

As shown in FIGS. 6-21, the umbrella 30 may be flush with the base 20. According to this embodiment, there is relatively little or no open area between the coupler 20 and the umbrella 30. This may be suitable for short height applications where there is little or a relatively short distance between the chassis and body panel, i.e. headliner and roof. Thus a body panel assembly may include magnetic fasteners of various heights. For example the magnetic fasteners of various heights may be used where the distance between the headliner and roof varies.

It is understood that the implementation of other variations and modifications of the present invention in its various aspects will be apparent to those of ordinary skill in the art and that the invention is not limited by the specific embodiments described. It is therefore contemplated to cover by the present invention any and all modifications, variations or equivalents that fall within the spirit and scope of the basic underlying principles disclosed and claimed herein.

What is claimed is:

1. A magnetic cable fastener comprising:
a base;
a loop coupler attached to the base, operable to attach to a cable;
a boss attached to the base; and
a magnetic fastener having a hole with a diameter to fasten with the boss .

2. The magnetic cable fastener of claim 1 wherein the loop coupler comprises at least two fingers operable to releasably hold a cable.

3. The magnetic cable fastener of claim 1 wherein the loop coupler is a closed loop.

4. The magnetic cable fastener of claim 1 wherein the loop coupler is operable to allow insertion of at least one of: a suitable wire, cable, conduit, electrical box, an adjustable strap, and a tie wrap.

5. The magnetic cable fastener of claim 1 wherein the boss has at least one of: a weld, an ultrasonic head, a prong, a nut, a rounded tip, a pointed tip, wedge, prong(s), spring, arms, spring fingers, washer, hook(s), rib lock, clamp, spring finger and a barb.

6. The magnetic cable fastener of claim 1 wherein at least one of: the umbrella, boss and base are comprised of at least one of: Polypropylene, glass fill, acetal, plastic, vinyl, rubber, plastisol, plastic, acetal, polyacetal, polyoxymethylene, nylon, fiberglass and carbon fiber and Acrylonitrile butadiene styrene (ABS).

7. The magnetic cable fastener of claim 1 further comprising an umbrella positioned between the base and the magnetic fastener wherein the umbrella spins, compresses, or flexes about the boss.

8. The magnetic cable fastener of claim 1 wherein the magnetic fastener further comprises a holder and a magnet.

9. A magnetic cable fastener comprising:
a base;
a loop coupler attached to the base operable to attach to a strap or cable;
a boss attached to the base; and
a magnetic fastener having a hole with a diameter to fasten with the boss and coupler.

10. The magnetic cable fastener of claim 9 wherein the loop coupler is a closed loop.

11. The magnetic cable fastener of claim 10 wherein the loop coupler is operable to allow insertion of an adjustable strap.

12. The magnetic cable fastener of claim 9 wherein the loop coupler comprises at least two fingers operable to releasably hold a cable.

13. The magnetic cable fastener of claim 9 wherein the boss has at least one of: a weld, an ultrasonic head, a prong, a nut, a rounded tip, a pointed tip, wedge, prong(s), spring, arms, spring fingers, washer, hook(s), rib lock, clamp, spring finger a pin, and a barb.

14. The magnetic cable fastener of claim 9 wherein at least one of: the coupler, boss and base are comprised of at least one of: Polypropylene, glass fill, acetal, plastic, vinyl, rubber, plastisol, plastic, acetal, polyacetal, polyoxymethylene, nylon, fiberglass and carbon fiber and Acrylonitrile butadiene styrene (ABS).

15. The magnetic cable fastener of claim 9 wherein the magnetic fastener further comprises a holder and magnet.

16. A vehicle and magnetic cable fastener comprising:
a vehicle chassis;
a magnetic cable fastener comprising:
a base;
a coupler attached to the base operable to attach to a strap or cable; and
a boss attached to the base; and
a magnetic fastener having a hole with a diameter attached via the boss and operable to fasten with the chassis.

17. The vehicle and magnetic cable fastener of claim 16 wherein the coupler is a closed loop.

18. The vehicle and magnetic cable fastener of claim 16 wherein the coupler is at least one of: an open loop, a closed loop and operable to allow insertion of an adjustable strap.

19. The vehicle and magnetic cable fastener of claim 16 wherein the loop coupler comprises at least two fingers operable to releasably hold a cable.
